(19) United States
(12) Patent Application Publication
(10) Pub. No.: US 2024/0186545 A1
(43) Pub. Date: Jun. 6, 2024

(54) FUEL CELL SYSTEM FREEZE-START SYSTEMS AND METHODS

(71) Applicant: Nikola Corporation, Phoenix, AZ (US)

(72) Inventors: Brandon Christopher Dunn, Gilbert, AZ (US); Akshit Markan, Tempe, AZ (US); Aris Papadopoulos, Mesa, AZ (US); Saradhi Rengarajan, Mesa, AZ (US)

(21) Appl. No.: 18/437,976

(22) Filed: Feb. 26, 2024

Related U.S. Application Data
(63) Continuation-in-part of application No. 18/322,283, filed on May 23, 2023.
Application No. 18/322,283 is a continuation-in-part of application No. 17/938,741, filed on Oct. 7, 2022.
(60) Provisional application No. 63/364,659, filed on May 13, 2022.

(51) Int. Cl. H01M 8/04223; B60L 58/31; B60L 58/34; H01M 8/04007; H01M 8/0432

(52) U.S. Cl. CPC H01M 8/04268; B60L 58/31; B60L 58/34; H01M 8/04007; H01M 8/04253; H01M 8/04358; H01M 2250/20

(57) ABSTRACT

The present disclosure provides a method for heating a dual stack fuel cell system of a vehicle. The method may include receiving a heat power request from a first fuel cell stack, receiving a first temperature of the first fuel cell stack and a second temperature of a second fuel cell stack, initiating, responsive to the first temperature and the second temperature indicating that the first fuel cell stack and the second fuel cell stack are frozen, a freeze-start thermal operating mode for the first fuel cell stack, and transferring, during the freeze-start thermal operating mode for the first fuel cell stack, heat from a brake resistor to the first fuel cell stack.

### CROSS-REFERENCE TO RELATED APPLICATIONS

This application is a continuation-in-part of co-pending U.S. Ser. No. 18/322,283 filed May 23, 2023, now U.S. Patent Application Publication No. 2023-0365026 entitled “FUEL CELL THERMAL MANAGEMENT CONTROL SYSTEMS AND METHODS.” U.S. Ser. No. 18/322,283 is a continuation-in-part of co-pending U.S. patent application Ser. No. 17/938,741 filed Oct. 7, 2022, now U.S. Patent Application Publication No. 2023-0364962 entitled “INTEGRATED THERMAL MANAGEMENT SYSTEM.” U.S. Ser. No. 17/938,741 claims priority to, and the benefit of, U.S. Provisional Patent Application Ser. No. 63/364,659 filed on May 13, 2022 entitled “INTEGRATED THERMAL MANAGEMENT SYSTEM.” The disclosures of each of the foregoing applications are incorporated herein by reference in their entireties, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

The present disclosure relates to thermal management systems, and more particularly, to thermal management systems for fuel cell vehicles.

### BACKGROUND

Fuel cell electric vehicles (FCEVs) utilize multiple fuel cells, combined in one or more fuel cell stacks, to generate an electric current to power one or more system components to operate the vehicle. For example, electric current generated by the fuel cell stack may be used to power one or more electric motors to drive the vehicle's wheels as well as power multiple other electrically operated systems of the vehicle. In freezing conditions, one or more of the fuel cell stacks may become frozen due to residual moisture in the stacks, thereby rendering the stacks inoperable until the stacks are adequately heated. As a result, new and improved methods for heating the stacks in freeze-start scenarios remain desirable.

### SUMMARY

A method for heating a dual stack fuel cell system of a vehicle may comprise receiving a heat power request from a first fuel cell stack, receiving a first temperature of the first fuel cell stack and a second temperature of a second fuel cell stack, initiating, responsive to the first temperature and the second temperature indicating that the first fuel cell stack and the second fuel cell stack are frozen, a freeze-start thermal operating mode for the first fuel cell stack, and transferring, during the freeze-start thermal operating mode for the first fuel cell stack, heat from a brake resistor to the first fuel cell stack.

In various embodiments, the first temperature may be a measured coolant temperature at an outlet of the first fuel cell stack and the second temperature may be a measured coolant temperature at an outlet of the second fuel cell stack. The method may further comprise comparing the heat power request to a threshold power value. The method may further comprise commanding, during the freeze-start thermal operating mode for the first fuel cell stack, a brake resistor power to a maximum operating power. The method may further comprise comparing the first temperature and the second temperature to a first threshold temperature to determine if the first fuel cell stack and the second fuel cell stack are frozen. The method may further comprise setting, during the freeze-start thermal operating mode for the first fuel cell stack, a coolant temperature setpoint at an outlet of the brake resistor. The method may further comprise controlling, during the freeze-start thermal operating mode for the first fuel cell stack, the brake resistor power based on the coolant temperature setpoint at the outlet of the brake resistor. The method may further comprise receiving a third temperature of the first fuel cell stack and a fourth temperature of the second fuel cell stack. The method may further comprise terminating, responsive to the third temperature or the fourth temperature being greater than or equal to a second threshold temperature, the freeze-start thermal operating mode for the first fuel cell stack.

A method for heating a dual stack fuel cell system of a vehicle may comprise receiving a heat power request from a first fuel cell stack, receiving a first temperature of the first fuel cell stack and a second temperature of a second fuel cell stack, determining a first thermal state of the first fuel cell stack using the first temperature and a second thermal state of the second fuel cell stack using the second temperature, initiating, responsive to the first thermal state being a frozen thermal state and the second thermal state being an operable thermal state, a freeze-start thermal operating mode for the first fuel cell stack, and transferring, during the freeze-start thermal operating mode for the first fuel cell stack, heat from the second fuel cell stack to the first fuel cell stack.

In various embodiments, the method may further comprise transferring, during the freeze-start thermal operating mode for the first fuel cell stack, heat from a brake resistor to the first fuel cell stack. The method may further comprise commanding, during the freeze-start thermal operating mode for the first fuel cell stack, a first valve to a fully open position and a second valve to a fully open position. The first valve may be positioned between the first fuel cell stack and a first coolant-coolant heat exchanger, and the second valve may be positioned between the second fuel cell stack and a second coolant-coolant heat exchanger. The first valve may permit a first coolant to pass through the first coolant-coolant heat exchanger when in the fully open position, and second valve may permit a second coolant to pass through the second coolant-coolant heat exchanger when in the fully open position. The method may further comprise commanding a brake resistor power to a maximum operating power. The method may further comprise commanding a pump speed of a pump in a brake resistor coolant loop to a maximum speed. The method may further comprise setting a coolant temperature at an outlet of the brake resistor.

A method of heating a dual stack fuel cell system of a vehicle may comprise receiving a first temperature of a first fuel cell stack and a second temperature of a second fuel cell stack, determining a first thermal state of the first fuel cell stack using the first temperature and a second thermal state of the second fuel cell stack using the second temperature, and commanding, responsive to a determination that the first thermal state is a frozen state and the second thermal state is a frozen state, a first valve to an open position to enable heat transfer from a brake resistor to the first fuel cell stack.

In various embodiments, the method may further comprise comparing the first temperature and the second temperature to a threshold temperature to determine the first thermal state and the second thermal state. The first valve may be positioned between the first fuel cell stack and a coolant-coolant heat exchanger thermally coupled to the brake resistor.

The contents of this section are intended as a simplified introduction to the disclosure and are not intended to limit the scope of any claim. The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

The accompanying drawings are included to provide a further understanding of the present disclosure and are incorporated in, and constitute a part of, this specification, illustrate various embodiments, and together with the description, serve to explain exemplary principles of the disclosure.

FIG. 1 illustrates a perspective view of an FCEV comprising a thermal management system, in accordance with various embodiments;

FIG. 2, FIG. 3, and FIG. 4 illustrate various embodiments of a thermal management system for an FCEV, in accordance with various embodiments;

FIG. 5 illustrates a high-level flow diagram of a method of heating a dual stack fuel cell system in a freeze-start scenario, in accordance with various embodiments; and

FIG. 6 illustrates a detailed flow diagram of a method of heating a dual stack fuel cell system in a freeze-start scenario, in accordance with various embodiments.

### DETAILED DESCRIPTION

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical chemical, electrical, and mechanical changes may be made without departing from the spirit and scope of the disclosure. Thus, the detailed description herein is presented for purposes of illustration only and not of limitation.

For example, the steps recited in any of the method or process descriptions may be executed in any suitable order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Additionally, any reference to without contact (or similar phrases) may also include reduced contact or minimal contact.

For example, in the context of the present disclosure, systems, methods, and articles may find particular use in connection with FCEVs, battery electric vehicles (including hybrid electric vehicles), compressed natural gas (CNG) vehicles, hythane (mix of hydrogen and natural gas) vehicles, and/or the like. However, various aspects of the disclosed embodiments may be adapted for performance in a variety of other systems. Further, in the context of the present disclosure, methods, systems, and articles may find particular use in any system requiring use of a fuel cell, brake resistor, and thermal management system of the same. As such, numerous applications of the present disclosure may be realized.

Modern electric vehicles utilize various power sources to provide electric current to one or more electric motors configured to drive the vehicle's wheels. Among the types of electric vehicles being researched and developed at a wide scale are FCEVs, particularly for heavy-duty applications. Similar to traditional internal combustion engine vehicles (ICEVs), FCEVs generate large amounts of heat through the operation of various systems. Among the systems that generate heat are the fuel cell system, which generates heat as a result of exothermic chemical reactions taking place in fuel cell catalyst layers, and the braking system, which generates heat due to friction in the case of friction braking systems and resistive heating in the case of regenerative braking systems. Traditionally, heat generated by the fuel cell system and the braking system was disposed of using discrete thermal management systems for the fuel cell and the braking system, respectively. However, integrating these thermal management systems can result in numerous benefits, namely, increased thermal efficiency, reduced part count, and reduced system complexity. Increasing thermal efficiency can result in increased range as less power is required to operate the thermal systems and instead can be used to power the electric motor(s). Reducing part count not only reduces costs but also can help reduce the space occupied by the thermal systems. Finally, reducing thermal system complexity can lead to greater vehicle uptime because the number of potential failure points and the time associated with maintenance and service tasks can be reduced.

In some situations, it may be necessary to preheat or thaw the fuel cell system at vehicle startup in order to allow the fuel cell system to operate as desired for typical vehicle operation. More specifically, in freezing ambient conditions (i.e., ambient temperatures less than or equal to 0° C.), residual moisture (i.e., liquid water and/or water vapor) in the fuel cell membranes, or auxiliary components associated with the fuel cell system, may freeze, preventing the fuel cell system from operation or operating in manner sufficient to achieve a desired power output, efficiency, and/or durability. Conventional FCEV thermal management systems aim to solve the above by including an electric heater configured to thaw the fuel cell system in a freeze-start scenario. While utilizing an electric heater to thaw the fuel cell system may be effective, it can increase part count, cost, system complexity, and vehicle weight. As a result, new and efficient thermal management systems and methods capable of thermally conditioning the fuel cell system in a freeze-start scenario, while utilizing necessary components of the vehicle architecture remain desirable.

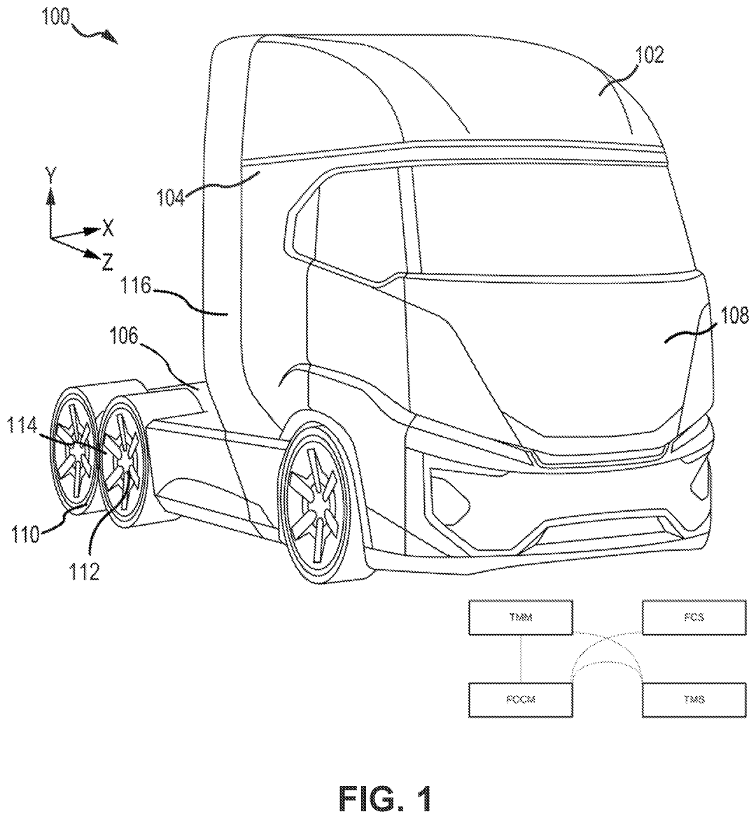

Accordingly, with reference to FIG. 1, a perspective view of a vehicle 100 incorporating a thermal management system is illustrated, in accordance with various embodiments. In various embodiments, vehicle 100 is an electric vehicle incorporating an electric powertrain. More specifically, vehicle 100 may be an electric commercial vehicle, such as, for example, a class 8 heavy-duty commercial vehicle. Vehicle 100 may be an FCEV, a battery electric vehicle (BEV), or any other vehicle comprising an energy source, a braking system, and a cabin utilizing thermal management. Moreover, vehicle 100 may comprise a commercial vehicle of a different weight class or a passenger vehicle in various embodiments. While discussed primarily herein as comprising an electric vehicle with an electric drivetrain, it should be appreciated that vehicle 100 may comprise any vehicle type in need of thermal management, including ICEVs of various sizes and applications.

Vehicle 100 comprises a body 102 which defines a cabin 104 configured to contain at least one passenger. For example, cabin 104 may comprise one or more seats, sleepers, or other features configured to provide comfort to an operator or other passenger. Vehicle 100 comprises a heating, ventilation, and air conditioning (HVAC) system which may provide clean air, heat, and cooling to cabin 104 depending on the ambient temperature where vehicle 100 is operating. While illustrated herein as comprising a cabover style body, body 102 is not limited in this regard and may comprise an American style or other style of body.

Vehicle 100 further comprises a battery system 106. Battery system 106 may be a rechargeable, or secondary, battery configured to store electrical energy from an external power source (for example, a charging station), from a fuel cell stack, from a solar panel disposed on vehicle 100, and/or from regenerative braking or other applications. Battery system 106 may release this stored electrical energy to power one or more electric motors and/or to supply power to other vehicle components requiring electricity to operate. In various embodiments, battery system 106 may be a lithium-ion battery, however, battery system 106 is not limited in this regard and may comprise other rechargeable battery types such as a lead-acid battery, nickel-cadmium battery, nickel-metal hydride battery, lithium iron sulfate battery, lithium iron phosphate battery, lithium sulfur battery, solid state battery, flow battery, or any other type of suitable battery. Battery system 106 may further comprise multiple battery cells coupled in series and/or parallel to increase voltage and/or current. The cells of battery system 106 may comprise any suitable structure including cylindrical cells, prismatic cells, or pouch cells. Moreover, battery system 106 may at least partially comprise other energy storage technologies such as an ultracapacitor.

In various embodiments, in addition to battery system 106, vehicle 100 comprises a fuel cell system 108. Fuel cell system 108 may comprise one or more fuel cells capable of facilitating an electrochemical reaction to produce an electric current. For example, the one or more fuel cells may be proton-exchange membrane (PEM) fuel cells which may receive a fuel source (such as diatomic hydrogen gas) which may react with an oxidizing agent (such as oxygen) to generate electricity with heat and water as byproducts. The fuel cells may be electrically coupled in series and/or parallel to increase voltage and/or current and form one or more fuel cell stacks, which together form fuel cell system 108. In various embodiments, fuel cell system 108 comprises a first fuel cell stack and a second fuel cell stack, however, fuel cell system 108 is not limited in this regard and may comprise a single stack, three stacks, four stacks, or more in various embodiments. In various embodiments, fuel cell system 108 may comprise fuel cells other than PEM fuel cells, for example, alkaline fuel cells, phosphoric acid fuel cells, molten carbonate fuel cells, solid oxide fuel cells, or any other suitable fuel cell type.

Battery system 106 and fuel cell system 108 may be configured to collectively or individually provide power to one or more electric motors in order to drive one or more wheels 110 of vehicle 100. For example, in various embodiments, vehicle 100 comprises an electric axle or eAxle 112 containing one or more electric motors and a gear assembly configured to provide torque to a drive shaft. Electric current may be delivered to the electric motor(s) via battery system 106 and/or fuel cell system 108. For example, in various embodiments, fuel cell system 108 may charge battery system 106 and battery system 106 may provide electric current to eAxle 112. Alternatively, fuel cell system 108 may provide electrical power directly to eAxle 112. In various embodiments, vehicle 100 comprises a 6×2 configuration with a single drive axle and two powered wheel ends, however, vehicle 100 is not limited in this regard and may comprise any suitable configuration, for example a 4×2, 6×4, 6×6, or other suitable configuration.

Vehicle 100 further comprises a braking system 114 with a brake assembly coupled to one or more of the wheel ends of vehicle 100. In various embodiments, braking system 114 comprises a regenerative braking system, a friction braking system, or a combination thereof. As vehicle 100 decelerates, the electric motor(s) in eAxle 112 may act as generators and convert kinetic energy to electrical energy to charge or recharge battery system 106. When battery system 106 is fully charged or unable to accept the amount of power generated by the regenerative braking system, some of the electrical energy may be dissipated as heat using one or more brake resistors 116. Dissipating excess electrical energy as heat may help prevent damage to certain system components (such as the electric motor) in response to large power spikes. Without thermal management, brake resistors 116 can overheat, and the vehicle must instead rely on the use of the friction braking system in order to slow the vehicle. Accordingly, thermal management of braking system 114 (and brake resistors 116 therein) is desirable.

In various embodiments, vehicle 100 further comprises one or more controllers (e.g., processors) and one or more tangible, non-transitory memories capable of implementing digital or programmable logic. In various embodiments, for example, the one or more controllers comprise one or more of a general-purpose processor, digital signal processor (DSP), application specific integrated circuit (ASIC), field programmable gate array (FPGA), or other programmable logic device, discrete gate, transistor logic, integrated circuit, or discrete hardware components, or any various combinations thereof or the like. In some embodiments, vehicle 100 comprises a thermal management module (TMM) in electrical, wireless, and/or logical communication with a thermal management system (TMS) (similar to thermal management systems 200, 300, 400 described below). TMM may be configured to command/actuate/control one or more components of the TMS. The TMM may be in further electrical, wireless, and/or logical communication with one or more other controllers, for example, a fuel cell control module (FCCM), which may be in electrical, wireless, and/or logical communication with a fuel cell system (FCS) (similar to fuel cell systems 108 and 210, 310, 410 described below). FCCM may be configured to communicate with and command/actuate/control fuel cell system (FCS) and/or one or more components of thermal management system (TMS).

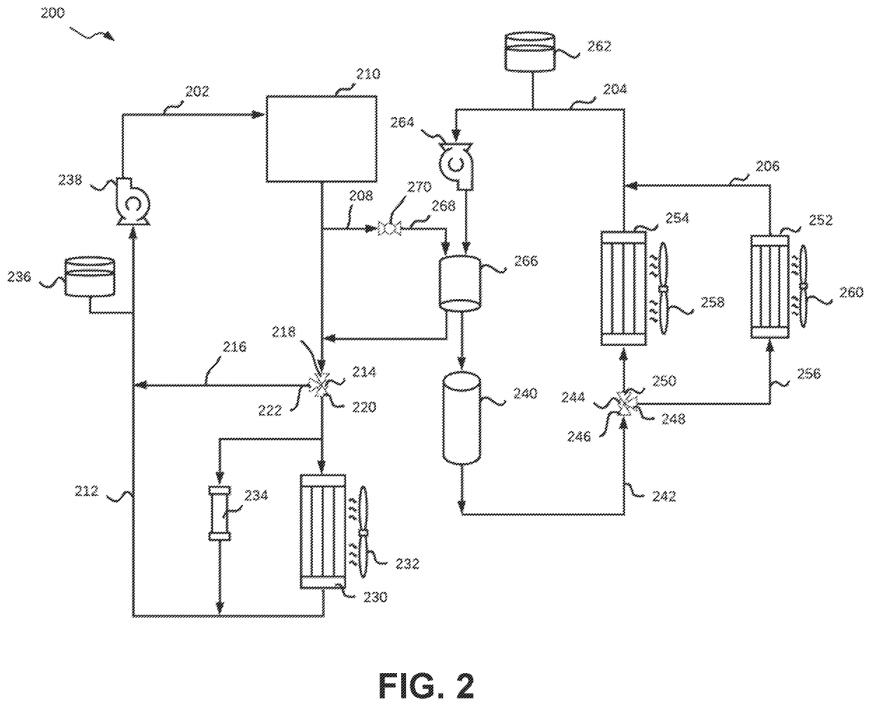

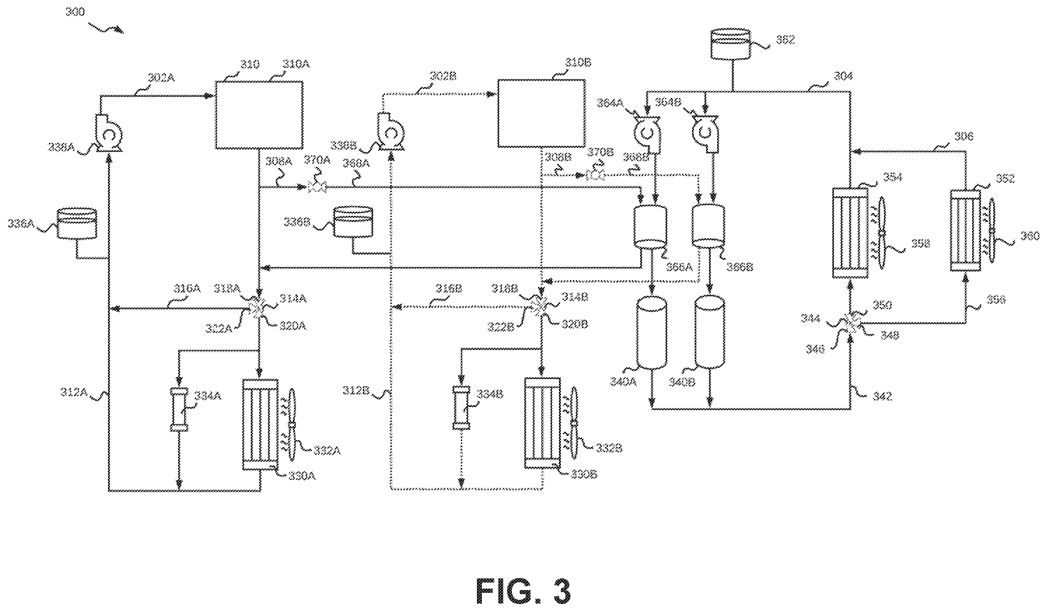

With reference to FIG. 2, a thermal management system 200 of vehicle 100 is illustrated, in accordance with various embodiments. In various embodiments, thermal management system 200 comprises a fuel cell coolant loop 202, a brake resistor coolant loop 204, an HVAC coolant loop 206, and a heat exchanger loop 208. Fuel cell coolant loop 202, brake resistor coolant loop 204, HVAC coolant loop 206, and heat exchanger loop 208 may be thermally and fluidly coupled together to form thermal management system 200. In general, thermal management system 200 may be capable of: cooling a fuel cell system 210 with fuel cell coolant loop 202, heating fuel cell system 210 with fuel cell coolant loop 202 (for example, during freeze-start scenarios), cooling a brake resistor 240 of brake resistor coolant loop 204, and heating cabin 104 of vehicle 100 through HVAC coolant loop 206. While discussed herein as comprising a fuel cell coolant loop 202, a brake resistor coolant loop 204, and an HVAC coolant loop 206, it should be appreciated more or fewer coolant loops may be included in thermal management system 200 (for example, a powertrain coolant loop, a battery coolant loop, and/or an electronics coolant loop). Moreover, in various embodiments, thermal management system 200 may also comprise one or more refrigeration loops, such as one or more vapor-compression refrigeration loops configured to provide additional cooling capacity to the systems or components of vehicle 100. Additionally, while labeled “fuel cell coolant loop,” it should be appreciated that fuel cell coolant loop 202 could be configured to thermally manage any heat generating, power delivering system with or without a fuel cell system (such as a battery system or internal combustion engine). Moreover, while labeled “brake resistor coolant loop,” it should be appreciated that brake resistor coolant loop 204 could be configured to thermally manage any heat generating braking system or component with or without a brake resistor (such as a friction braking system).

Fuel cell coolant loop 202 is configured to provide heat to or remove heat from fuel cell system 210 (which may be the same as fuel cell system 108 described in relation to FIG. 1) depending on ambient temperatures and operating conditions. In various embodiments, such as the embodiment illustrated in FIG. 2, fuel cell system 210 comprises a single fuel cell stack. In various embodiments, fuel cell system 210 is thermally and fluidly coupled to the other components of fuel cell coolant loop 202 via a fuel cell coolant line 212. Fuel cell coolant line 212 may be configured to contain a first coolant configured to absorb and transfer heat. In various embodiments, the first coolant in fuel cell coolant loop 202 comprises a chemically inert fluid having a high thermal capacity and a relatively low viscosity. The first coolant may comprise a gaseous fluid such as air, helium, or other inert gas, or may comprise a liquid fluid such as water, ethylene glycol, propylene glycol, betaine, polyalkylene glycol, or other suitable coolant. Too much conductivity in the first coolant for fuel cell system 210 may adversely impact fuel cell performance and/or longevity, so deionized coolant such as water or water/glycol mixture may be desirable. Moreover, increased coolant conductivity could decrease the isolation resistance of the vehicle, thereby creating a safety hazard for persons interacting with the vehicle such as operators, service technicians, and/or first responders. In various embodiments, the first coolant of fuel cell coolant loop 202 comprises additives such as non-ionic corrosion inhibitors and/or ion-suppressing compounds such as ion-exchange nanoparticles. The first coolant of fuel cell coolant loop 202 may comprise a conductivity of less than 10 μS/cm, a conductivity of less than 5 μS/cm, or a conductivity of less than 2 μS/cm in various embodiments.

Fuel cell coolant loop 202 further comprises a first valve 214. First valve 214 is downstream of and thermally and fluidly coupled to fuel cell system 210 via fuel cell coolant line 212. In various embodiments, first valve 214 comprises a diverting valve such as a three-way valve, for example. Stated otherwise, first valve 214 may comprise three openings, including one inlet and two outlets. First valve 214 is configured to receive the first coolant from fuel cell system 210 through inlet 218 and, depending on an operating mode, deliver the first coolant through first outlet 220 (to a fuel cell radiator as will be discussed in further detail below), deliver the first coolant through second outlet 222 (to bypass the fuel cell radiator as will be discussed in further detail below), or deliver a portion of the first coolant through first outlet 220 and deliver a portion of the first coolant through second outlet 222. In various embodiments, first valve 214 may be configured with multiple positions to adjust the amount of the first coolant that is directed through first outlet 220 and second outlet 222, respectively. In various embodiments, first valve 214 is configured with 90 discrete positions, however, first valve 214 is not limited in this regard and may comprise a valve configured with more or fewer positions.

Fuel cell coolant loop 202 further comprises a fuel cell radiator 230 downstream of and thermally and fluidly coupled to first valve 214 via fuel cell coolant line 212. Fuel cell coolant loop 202 may further comprise one or more T connectors or Y connectors downstream of first valve 214 and upstream of fuel cell radiator 230. Depending on an operating mode, the first coolant may be configured to flow through first outlet 220 of first valve 214, into an inlet of fuel cell radiator 230, and out of an outlet of fuel cell radiator 230. Fuel cell radiator 230 may be configured to transfer heat stored in the first coolant (resulting from the transfer of heat from fuel cell system 210 to the first coolant, for example) to an external environment (for example, the ambient environment external to vehicle 100). While illustrated as comprising a single radiator, fuel cell radiator 230 is not limited in this regard and may comprise two or more radiators coupled in series and/or parallel. Fuel cell radiator 230 may comprise internal, serpentine tubing configured to contain and route the first coolant and one or more fins (or similar structures) that are configured to increase surface area. As heated coolant flows through the tubing of fuel cell radiator 230, heat may be transferred to the external environment via (or primarily via) convective heat transfer. As a result, the first coolant may be cooled as it flows through fuel cell radiator 230. In various embodiments, fuel cell radiator 230 is equipped with a fan 232, which may assist in convective heat transfer to the external environment. However, in various embodiments, fuel cell radiator 230 is devoid of a fan and instead utilizes air flowing into and/or around vehicle 100 to assist in heat transfer, which may reduce power consumption resulting from operation of the fan.

In various embodiments, fuel cell coolant loop 202 further comprises an ion exchanger 234 downstream of and thermally and fluidly coupled to first valve 214 via fuel cell coolant line 212. Depending on the operating mode, the first coolant may be configured to flow through first outlet 220 of first valve 214, into an inlet of ion exchanger 234, and out of an outlet of ion exchanger 234. Ion exchanger 234 may be configured to reduce the conductivity of the first coolant as the first coolant passes through ion exchanger 234. In various embodiments, ion exchanger 234 comprises a cartridge housing comprising a resin having a mixed bed of negatively charged anions and positively charged cations. The mixed bed may be configured with any suitable anion/cation ratio, for example, 1:1, 2:1, 1:2, or other desired ratio. As the first coolant travels through ion exchanger 234, anions in the first coolant may react with cations in ion exchanger 234 and cations in the first coolant may react with anions in ion exchanger 234. As a result, the conductivity of the first coolant may be reduced. The first coolant flowing through ion exchanger 234 may be reintroduced to fuel cell coolant line 212 downstream of ion exchanger 234, for example via a T connector or Y connector.

In various embodiments, fuel cell coolant loop 202 comprises a T connector or Y connector upstream of fuel cell radiator 230 and ion exchanger 234. The T connector or Y connector may permit the first coolant coming from first valve 214 to be split into two flow paths, with a first flow path being configured to flow through fuel cell radiator 230 and a second flow path being configured to flow through ion exchanger 234. As a result, at least a portion of the first coolant may continually be deionized by being passed through ion exchanger 234. The two flow paths may recombine downstream of fuel cell radiator 230 and ion exchanger 234 through the use of another T connector or Y connector.

Alternatively, fuel cell coolant loop 202 may be configured such that, depending on an operating mode, all of the first coolant is passed through fuel cell radiator 230 or all of the first coolant is passed through ion exchanger 234. For example, in various embodiments, the T connector or Y connector upstream of fuel cell radiator 230 and ion exchanger 234 may be replaced with a valve configured to permit or prevent flow to fuel cell radiator 230 or ion exchanger 234. Fuel cell coolant loop 202 may default to passing the first coolant through fuel cell radiator 230 rather than ion exchanger 234. For example, in various embodiments, the valve may be configured such that a first outlet (to fuel cell radiator 230) is normally open and a second outlet (to ion exchanger 234) is normally closed. As a result, absent some signal indicating an instruction to pass the first coolant through ion exchanger 234, the first coolant is passed through fuel cell radiator 230 instead of ion exchanger 234. In various embodiments, thermal management system 200 may be configured such that the first coolant is passed through ion exchanger 234 at predetermined time increments (for example, at vehicle startup or shutdown, once a minute, once an hour, once a day, and so on) or in response to a measured conductivity of the first coolant exceeding a threshold value (for example, >2 μS/cm, >5 μS/cm, >10 μS/cm). In various embodiments, fuel cell coolant loop 202 further comprises a conductivity sensor that may be placed in any suitable position in fuel cell coolant loop 202, such as on an expansion tank, downstream of fuel cell system 210, downstream of first valve 214, or upstream and/or downstream of ion exchanger 234. Moreover, while illustrated being thermally and fluidly connected in parallel, fuel cell coolant loop 202 is not limited in this regard and fuel cell radiator 230 and ion exchanger 234 may be thermally and fluidly coupled in series with ion exchanger 234 immediately upstream or downstream of fuel cell radiator 230 in various embodiments. Coupling fuel cell radiator 230 and ion exchanger 234 in parallel as opposed to series can reduce and/or minimize a pressure drop in fuel cell coolant line 212.

Fuel cell coolant loop 202 further comprises a first expansion tank 236 downstream of and thermally and fluidly coupled to first valve 214, fuel cell radiator 230, and ion exchanger 234. Depending on an operating mode, first expansion tank 236 may be configured to receive the first coolant directly from first valve 214, fuel cell radiator 230, or ion exchanger 234. For operating modes in which fuel cell radiator 230 and ion exchanger 234 are bypassed, the first coolant may be directed out of second outlet 222 of first valve 214. A T connector or Y connector may fluidly couple together a bypass line 216 connected to the second outlet 222 of first valve 214 and fuel cell coolant line 212. First expansion tank 236 may be configured to protect fuel cell coolant loop 202 by removing excess pressure resulting from heated coolant. For example, as the first coolant travels throughout fuel cell coolant loop 202, the first coolant may absorb heat from various systems, including fuel cell system 210, and the temperature of the first coolant may elevate despite heat transfer taking place in fuel cell radiator 230 or other system component. As the first coolant expands with an increase in temperature, first expansion tank 236 may be configured to accommodate the pressure increase to avoid exceeding a threshold pressure limit of fuel cell coolant loop 202 and/or prevent undesired venting of the first coolant. In various embodiments, first expansion tank 236 comprises a compression expansion tank, bladder expansion tank, diaphragm expansion tank, or any other suitable expansion tank type.

In various embodiments, fuel cell coolant loop 202 further comprises a first pump 238 that may be downstream of first expansion tank 236 and upstream of fuel cell system 210. Similar to all other components or systems of fuel cell coolant loop 202, first pump 238 is thermally and fluidly coupled to first expansion tank 236 and fuel cell system 210 via fuel cell coolant line 212. First pump 238 may be configured to circulate the first coolant throughout fuel cell coolant loop 202. First pump 238 may comprise any suitable fluid pump such as a centrifugal pump, diaphragm pump, gear pump, peripheral pump, reciprocating pump, rotary pump, or other suitable pump.

With continued reference to FIG. 2, as discussed above, thermal management system 200 further comprises brake resistor coolant loop 204, which may be configured to manage and/or repurpose heat generated by a brake resistor 240. While discussed herein as being configured to manage heat from brake resistor 240, it should be appreciated that brake resistor coolant loop 204 may be configured to manage heat generated from any braking system or component, such as other brake system electronics or friction brakes, for example. Brake resistor 240 may be thermally and fluidly coupled to every other component/system of brake resistor coolant loop 204 via a brake resistor coolant line 242. Brake resistor coolant line 242 contains a second coolant configured to absorb and transfer heat. In various embodiments, the second coolant in brake resistor coolant loop 204 may be the same as or different from the first coolant in fuel cell coolant loop 202. Using separate coolants in brake resistor coolant loop 204 and fuel cell coolant loop 202 can reduce, minimize, and/or limit the conductivity of the coolant passing through fuel cell system 210 because ions generated by the components of brake resistor coolant loop 204 are isolated from fuel cell coolant loop 202.

In various embodiments, brake resistor 240 is thermally and fluidly coupled to a third valve 244 via brake resistor coolant line 242. Similar to first valve 214, third valve 244 comprises a diverting valve such as a three-way valve. In various embodiments, third valve 244 comprises a single inlet and two outlets. For example, third valve 244 may comprise an inlet 246 configured to receive the second coolant from brake resistor 240, a first outlet 248 configured to deliver the second coolant to a cabin heater core 252 of HVAC coolant loop 206 via an HVAC coolant line 256, and a second outlet 250 configured to deliver the second coolant to a brake resistor radiator 254 via brake resistor coolant line 242. Depending on an operating mode, third valve 244 may be configured to deliver the second coolant only to cabin heater core 252 and prevent the second coolant from flowing to brake resistor radiator 254, may be configured to deliver the second coolant only to brake resistor radiator 254 and prevent the second coolant from flowing to cabin heater core 252, or may be configured to deliver a portion of the second coolant to brake resistor radiator 254 and deliver a portion of the second coolant to cabin heater core 252. In various embodiments, third valve 244 may be configured with multiple positions to adjust the amount of the first coolant that is directed through first outlet 248 and second outlet 250, respectively. In various embodiments, third valve 244 is configured with 90 discrete positions, however, third valve 244 is not limited in this regard and may comprise a valve configured with more or fewer positions.

Brake resistor radiator 254 may be substantially similar to fuel cell radiator 230 in various embodiments. Brake resistor radiator 254 may be configured to transfer heat stored in the second coolant (resulting from the transfer of heat from brake resistor 240 to the second coolant, for example) to the external environment (for example, the ambient environment external to vehicle 100). While illustrated as comprising a single radiator, brake resistor radiator 254 is not limited in this regard and may comprise two or more radiators coupled in series and/or parallel. Brake resistor radiator 254 may comprise internal, serpentine tubing configured to contain and route the second coolant and one or more fins (or similar structures) that are configured to increase surface area. As heated coolant flows through the tubing of brake resistor radiator 254, heat may be transferred to the external environment via (or primarily via) convective heat transfer. As a result, the second coolant may be cooled as it flows through brake resistor radiator 254. In various embodiments, brake resistor radiator 254 is equipped with a fan 258, which may assist in convective heat transfer to the external environment. However, in various embodiments, brake resistor radiator 254 is devoid of a fan and instead utilizes air flowing into and/or around vehicle 100 to assist in heat transfer, which may reduce power consumption resulting from operation of the fan.

In various embodiments, cabin heater core 252 may be substantially similar to fuel cell radiator 230 and brake resistor radiator 254. However, rather than transferring heat to the external environment, cabin heater core 252 may be configured to transfer heat in the second coolant to cabin 104. While illustrated as comprising a single heater core, cabin heater core 252 is not limited in this regard and may comprise two or more heater cores coupled in series and/or parallel. Cabin heater core 252 may comprise internal, serpentine tubing configured to contain and route the second coolant and one or more fins (or similar structures) that are configured to increase surface area. As heated coolant flows through the tubing of cabin heater core 252, heat may be transferred to cabin 104 (or primarily via) convective heat transfer. As a result, the second coolant may be cooled as it flows through cabin heater core 252. In various embodiments, cabin heater core 252 is equipped with a fan 260, which may assist in convective heat transfer to cabin 104. However, in various embodiments, cabin heater core 252 is devoid of a fan and instead utilizes air flowing into and/or around vehicle 100 to assist in heat transfer, which may reduce power consumption resulting from operation of the fan.

HVAC coolant line 256 and brake resistor coolant line 242 are thermally and fluidly coupled together downstream of cabin heater core 252 and brake resistor radiator 254. For example, depending on the operating mode, the second coolant may flow into an inlet of brake resistor radiator 254, out of an outlet of brake resistor radiator 254, and continue to flow through brake resistor coolant line 242. Alternatively, the second coolant may flow into an inlet of cabin heater core 252, out of an outlet of cabin heater core 252, and continue to flow through HVAC coolant line 256. A fluid fitting such as a T connector or Y connector may fluidly couple together brake resistor coolant line 242 and HVAC coolant line 256.

In various embodiments, brake resistor coolant loop 204 further comprises a second expansion tank 262 downstream of and thermally and fluidly coupled to brake resistor radiator 254 and cabin heater core 252. In various embodiments, second expansion tank 262 and first expansion tank 236 may be identical to one another; in other embodiments, second expansion tank 262 and first expansion tank 236 may differ in one or more characteristics (for example, size, shape, volume, and/or the like). Second expansion tank 262 may be configured to protect brake resistor coolant loop 204 and/or HVAC coolant loop 206 by removing excess pressure resulting from heated coolant. For example, as the second coolant travels throughout brake resistor coolant loop 204 and/or HVAC coolant loop 206, the second coolant may absorb heat from various systems, including brake resistor 240, and the temperature of the second coolant may elevate despite heat transfer taking place in brake resistor radiator 254 or cabin heater core 252. As the second coolant expands with an increase in temperature, second expansion tank 262 may be configured to accommodate the pressure increase to avoid exceeding a threshold pressure limit of brake resistor coolant loop 204 or HVAC coolant loop 206 and/or prevent undesired venting of the second coolant. In various embodiments, second expansion tank 262 comprises a compression expansion tank, bladder expansion tank, diaphragm expansion tank, or any other suitable expansion tank type. In various embodiments, brake resistor coolant loop 204 further comprises a second pump 264 downstream of and thermally and fluidly coupled to second expansion tank 262. Second pump 264 and first pump 238 may be identical to one another; in other embodiments, second pump 264 and first pump 238 may differ in one or more characteristics (e.g., power draw, flow rate, type of pump, size, shape, and/or the like). Second pump 264 may be configured to circulate the first coolant throughout brake resistor coolant loop 204 and/or HVAC coolant loop 206. Second pump 264 may comprise any suitable fluid pump such as a centrifugal pump, diaphragm pump, gear pump, peripheral pump, reciprocating pump, rotary pump, or other suitable pump.

As briefly discussed above, thermal management system 200 further comprises a heat exchanger loop 208. In various embodiments, thermal management system 200 comprises a coolant-coolant heat exchanger 266 downstream of and thermally and fluidly coupled to second pump 264 of brake resistor coolant loop 204. Coolant-coolant heat exchanger 266 is further thermally and fluidly coupled to fuel cell coolant loop 202 via a heat exchanger line 268. Coolant-coolant heat exchanger 266 may be configured to exchange heat between the first coolant in fuel cell coolant loop 202 and the second coolant in brake resistor coolant loop 204. For example, depending on the operating mode, heat stored in the first coolant may be transferred to the second coolant as the first coolant and second coolant flow through coolant-coolant heat exchanger 266. Alternatively, depending on the operating mode, heat stored in the second coolant may be transferred to the first coolant as the first coolant and second coolant flow through coolant-coolant heat exchanger 266. As a result, waste heat generated by one system or component (for example, fuel cell system 210 or brake resistor 240) may be repurposed and used to heat another system or component depending on operating conditions. While illustrated herein as comprising a single pump 264, coolant-coolant heat exchanger 266, and brake resistor 240, it should be appreciated that thermal management system 200 is not limited in this regard and may comprise a plurality of pumps, coolant-coolant heat exchangers, and brake resistors in various embodiments. In some exemplary embodiments, thermal management system 200 comprises a pump, coolant-coolant heat exchanger, and brake resistor for each fuel cell stack included in fuel cell system 210. In some exemplary embodiments, thermal management system 200 comprises a pump, coolant-coolant heat exchanger, and brake resistor for each side (driver and passenger) of vehicle 100.

Coolant-coolant heat exchanger 266 may comprise any suitable heat exchanger type. For example, in various embodiments, coolant-coolant heat exchanger 266 comprises a single-phase heat exchanger having any suitable structure. Coolant-coolant heat exchanger 266 may comprise a shell and tube heat exchanger, gasketed plate heat exchanger, welded plate heat exchanger, spiral plate heat exchanger, lamella heat exchanger, plate and fin heat exchanger, tube fin heat exchanger, heat pipe heat exchanger, double pipe heat exchanger, or any other suitable type of heat exchanger. Moreover, coolant-coolant heat exchanger 266 may be configured with any suitable flow arrangement for the first coolant and the second coolant. For example, in various embodiments, coolant-coolant heat exchanger 266 is a cocurrent flow heat exchanger, countercurrent flow heat exchanger, crossflow heat exchanger, or hybrid (cross and counterflow) heat exchanger.

In various embodiments, heat exchanger loop 208 further comprises a second valve 270 downstream of and thermally and fluidly coupled to fuel cell system 210 and upstream of and thermally and fluidly coupled to coolant-coolant heat exchanger 266. While discussed herein as being positioned upstream of coolant-coolant heat exchanger 266, heat exchanger loop 208 is not limited in this regard and second valve 270 may be positioned downstream of coolant-coolant heat exchanger 266 or anywhere on heat exchanger line 268. In various embodiments, second valve 270 is a normally closed or a normally open electronic shutoff valve. In various embodiments, second valve 270 is configured with a set of discrete positions, for example 90 discrete positions, to allow a desired percentage of coolant to flow through coolant-coolant heat exchanger 266. Depending on the operating mode, second valve 270 may be configured to receive the first coolant from fuel cell coolant loop 202 and allow the first coolant to flow to coolant-coolant heat exchanger 266 or may be configured to prevent the first coolant from flowing to coolant-coolant heat exchanger 266. In various embodiments, the position of second valve 270 (as well as the positions of first valve 214, third valve 244, and speeds of various pumps and fans) may be determined based on communication signals sent by an onboard thermal management module. In various embodiments, fuel cell coolant loop 202 and heat exchanger loop 208 are thermally and fluidly coupled together via one or more T connectors or Y connectors which may fluidly couple together fuel cell coolant line 212 and heat exchanger line 268.

In the figures, similar reference numerals may be utilized to denote similar components. For example, expansion tank 236 shown in an embodiment illustrated in FIG. 2 and discussed hereinabove may be similar to or identical to expansion tanks 336A and 336B shown in an embodiment illustrated in FIG. 3, which in turn may be similar to or identical to expansion tanks 436A and 436B shown in an embodiment illustrated in FIG. 4, and so forth. The discussion of one or more components shown in FIG. 2 may likewise apply to similar or identical components shown in FIG. 3 and/or FIG. 4; however, the discussion of these components in relation to FIG. 3 and/or FIG. 4 will not be repeated for the sake of brevity.

With reference now to FIG. 3, a thermal management system 300 for vehicle 100 is illustrated, in accordance with various embodiments. The architecture and function of thermal management system 300 substantially aligns with the architecture and function of thermal management system 200 discussed above, however, thermal management system 300 may be configured to thermally manage a dual (or two) stack fuel cell system 310 instead of a single stack fuel cell system. More specifically, fuel cell system 310 comprises a first fuel cell stack 310A and a second fuel cell stack 310B. In some embodiments, first fuel cell stack 310A and second fuel cell stack 310B are substantially identical in terms of structure, power output, operating voltage, balance of plant, and other characteristics. In some embodiments, first fuel cell stack 310A and second fuel cell stack 310B differ in one or more of the above. In some embodiments, first fuel cell stack 310A and second fuel cell stack 310B are enclosed in a common housing, however, in other embodiments, first fuel cell stack 310A and second fuel cell stack 310B are enclosed in distinct housings. In some embodiments, first fuel cell stack 310A is located proximate to the driver side of vehicle 100 and second fuel cell stack 310B is located proximate to the passenger side of vehicle 100.

In order to effectively and uniformly thermally manage first fuel cell stack 310A and second fuel cell stack 310B, one or more components, systems, and/or coolant loops may be duplicated in thermal management system 200 discussed above. For example, in various embodiments, thermal management system 300 comprises a first fuel cell coolant loop 302A and a second fuel cell coolant loop 302B. First fuel cell coolant loop 302A may be configured to provide heat to/remove heat from first fuel cell stack 310A, while second fuel cell coolant loop 302B may be configured to provide heat to/remove heat from second fuel cell stack 310B. Architecturally, both first fuel cell coolant loop 302A and second fuel cell coolant loop 302B may be identical to fuel cell coolant loop 202 described in relation to FIG. 2. However, in some embodiments, certain components (for example, fans 332A and 332B) may be common to both fuel cell coolant loops to increase thermal management system efficiency.

In addition to comprising two fuel cell stacks and two fuel cell coolant loops, vehicle 100 and/or thermal management system 300 may further comprise two brake resistor coolant loop pumps (364A and 364B), two coolant-coolant heat exchangers (366A and 366B), and two brake resistors (340A and 340B). In some embodiments, the brake resistor coolant loop pumps 364A/364B, the coolant-coolant heat exchangers 366A/366B, and the brake resistors 340A/340B are arranged in parallel, however, the arrangement of these components is not limited in this regard. Placing brake resistor coolant loop pumps 364A and 364B in parallel achieves a number of benefits, namely, increased coolant flow rates, easier controllability, lower system pressures, and improved reliability and redundancy. In various embodiments, first coolant-coolant heat exchanger 366A may be configured to permit heat transfer between first fuel cell coolant loop 302A (and first fuel cell stack 310A) and first brake resistor 340A and/or second brake resistor 340B, and second coolant-coolant heat exchanger 366B may be configured to permit heat transfer between second fuel cell coolant loop 302B (and second fuel cell stack 310B) and first brake resistor 340A and/or second brake resistor 340B. More specifically, as will be discussed in further detail below, first brake resistor 340A and/or second brake resistor 340B may be configured to selectively provide heat to first fuel cell stack 310A and/or second fuel cell stack 310B, for example, in freeze-start scenarios, via selective actuation of valves 370A and/or 370B.

With reference now to FIG. 4, a thermal management system 400 for vehicle 100 is illustrated, in accordance with various embodiments. Similar to thermal management system 300 described above, thermal management system 400 may be configured to thermally manage two fuel cell stacks 410A/410B using corresponding fuel cell coolant loops 402A/402B. The architecture and function of thermal management system 400 may be identical to the architecture and function of thermal management system 300 described above, with the exception that thermal management system 400 may differ in the number and arrangement of brake resistor coolant loop pumps and brake resistors. More specifically, thermal management system 400 may include a first brake resistor coolant loop pump 464A upstream of a pair of coolant-coolant heat exchangers 466A/466B arranged in parallel, a single brake resistor 440 downstream of the pair of coolant-coolant heat exchangers 466A/466B, and a second brake resistor coolant loop pump 464B downstream of brake resistor 440. Arranging the brake resistor coolant loop pumps 464A and 464B in this manner (with described components in between) results in a number of benefits, namely, higher coolant flow rates, and improved system reliability and redundancy. In various embodiments, first coolant-coolant heat exchanger 466A may be configured to permit heat transfer between first fuel cell coolant loop 402A (and first fuel cell stack 410A) and brake resistor 440, and second coolant-coolant heat exchanger 466B may be configured to permit heat transfer between second fuel cell coolant loop 402B (and second fuel cell stack 410B) and brake resistor 440. More specifically, as will be discussed in further detail below, brake resistor 440 may be configured to selectively provide heat to first fuel cell stack 410A and/or second fuel cell stack 410B, for example, in freeze-start scenarios, via selective actuation of valves 470A and/or 470B.

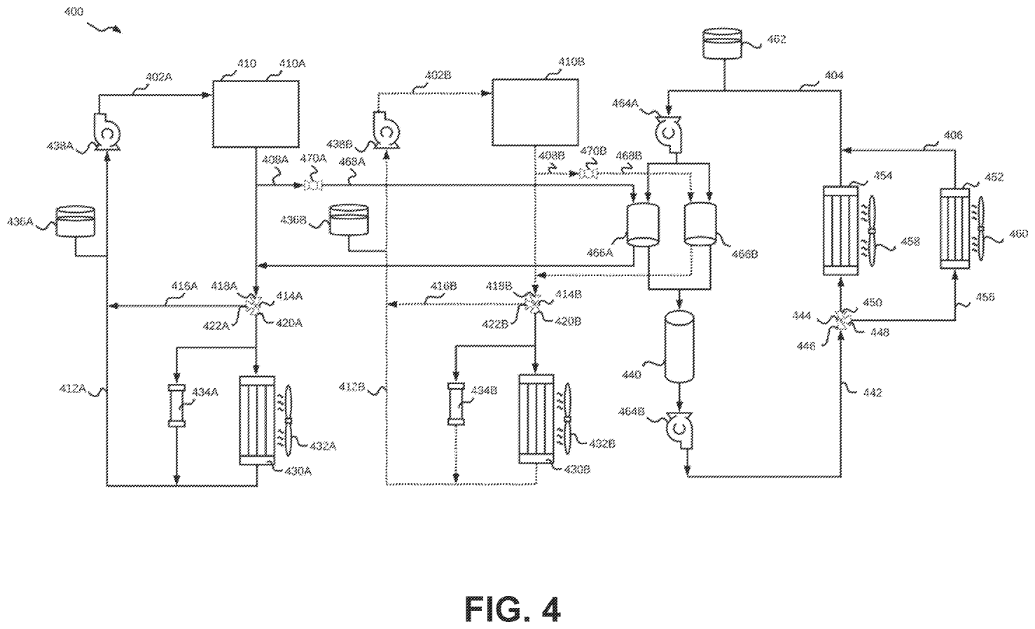

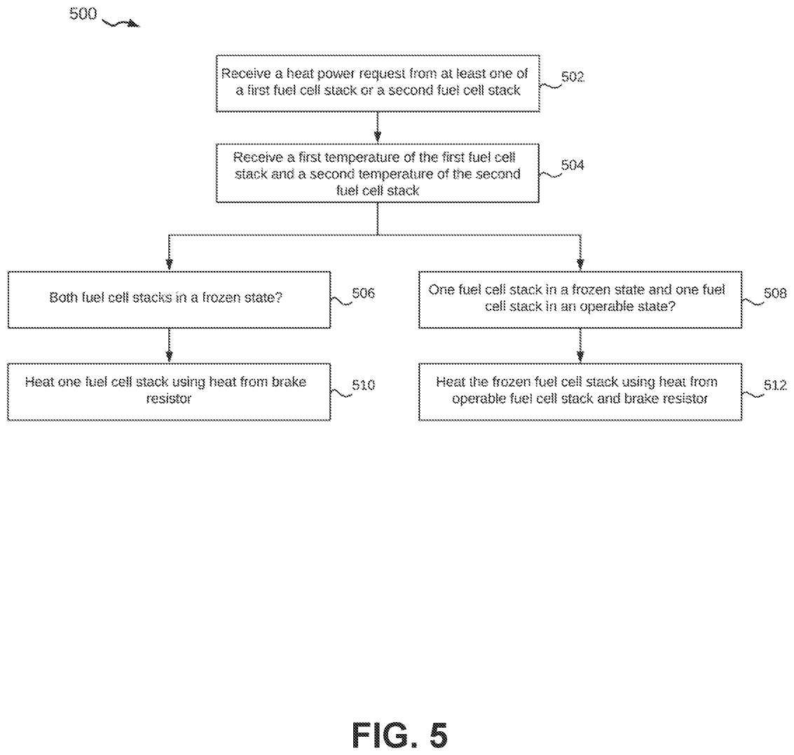

Referring now to FIG. 5, a high-level flow diagram of a method 500 of heating a dual fuel cell stack fuel cell system in a freeze-start scenario is illustrated, in accordance with various embodiments. Method 500 may comprise receiving a heat power request from at least one of a first fuel cell stack or a second fuel cell stack (block 502). In various embodiments, the heat power request may be received by a first controller (e.g., TMM) from a second controller (e.g., FCCM) or from the relevant fuel cell stack. In various embodiments, the heat power request may be in the form of a power value (in kW) and may correspond to the heating power needed by the relevant fuel cell stack. In various embodiments, the first controller (e.g., TMM) may be configured to calculate and/or command the brake resistor power as needed, in part, by using the heat power request as an input.

Method 500 may further comprise receiving a first temperature of the first fuel cell stack and a second temperature of the second fuel cell stack (block 504). In certain embodiments, the first temperature of the first fuel cell stack and the second temperature of the second fuel cell stack are measured coolant temperatures at the outlets of the first fuel cell stack and second fuel cell stack, respectively. In other embodiments, the first temperature and the second temperature are internal fuel cell stack temperatures, external fuel cell stack temperatures, coolant temperatures at the inlets of the respective stacks, or a combination thereof.

Method 500 may further comprise determining if the first fuel cell stack and the second fuel cell stack are in a frozen state (block 506), or alternatively, determining if one of the first fuel cell stack or the second fuel cell stack is in a frozen state and the other of the first fuel cell stack or second fuel cell stack is in an operable state (block 508). In various embodiments, determining whether one or both of the first fuel cell stack and/or the second fuel cell stack are in a frozen state or in an operable state may comprise comparing the first temperature and the second temperature to one or more threshold temperatures. In some embodiments, the determination that both the first fuel cell stack and the second fuel cell stack are in a frozen state results from the first temperature and the second temperature being less than a first threshold temperature. In some embodiments, the determination that one of the first fuel cell stack or the second fuel cell stack is in a frozen state and the other of the first fuel cell stack or second fuel cell stack is in an operable state results from one of the first temperature or second temperature being greater than or equal to the first threshold temperature and the other of the first temperature or second temperature being less than a second threshold temperature. In some embodiments, the fuel cell stack in a frozen state may be incapable of operating, and therefore incapable of generating its own heat, while the fuel cell stack in an operable state may be capable of generating its own heat.

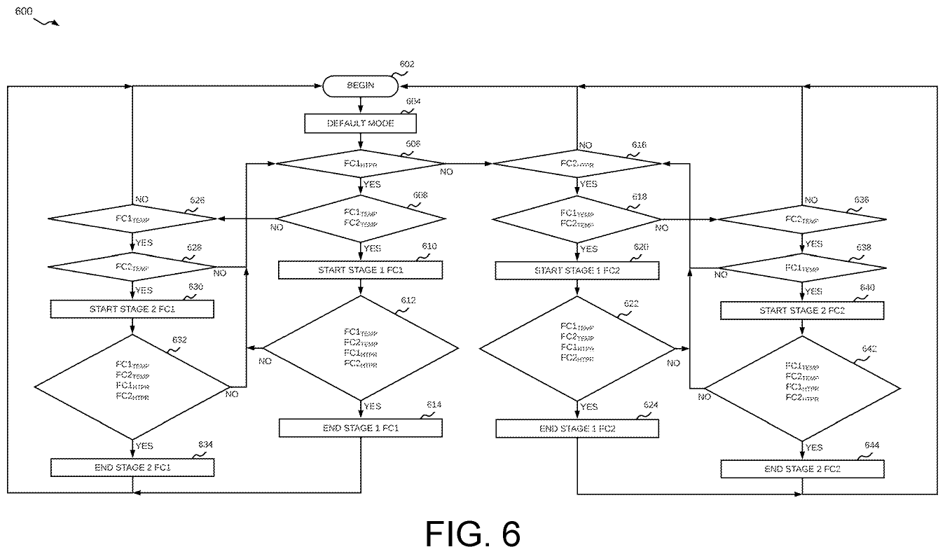

Method 500 may further comprise heating one of the first fuel cell stack or the second fuel cell stack using heat from a brake resistor in the event both the first fuel cell stack and the second fuel cell stack are determined to be in a frozen state (block 510). In some embodiments, heating one of the first fuel cell stack or the second fuel cell stack using heat from the brake resistor comprises heating the fuel cell stack from which the heat power request was received. As will be discussed in further detail with respect to FIG. 6 below, heating one of the first fuel cell stack or the second fuel stack using heat from the brake resistor comprises commanding one or more thermal system components and setting one or more temperature setpoints.

Method 500 may further comprise heating the fuel cell stack in a frozen state using heat from the fuel cell stack in an operable state and the brake resistor in the event one fuel cell stack is determined to be in a frozen state and one fuel cell stack is determined to be in an operable state (block 512). As will be discussed in further detail with respect to FIG. 6 below, heating the fuel cell stack in a frozen state using heat from the fuel cell stack in an operable state and the brake resistor comprises commanding one or more thermal system components and setting one or more temperature setpoints.

Referring now to FIGS. 3 and 6, a detailed flow diagram of a method 600 of heating a dual fuel cell stack fuel cell system in a freeze-start scenario is illustrated, in accordance with various embodiments. Method 600 may be more detailed but similar to method 500 described above. In various embodiments, method 600 utilizes the thermal management system architectures and functions described in relation to FIGS. 3 and 4 above and may include electrical, wireless, and/or logical communications between one or more controllers (e.g., TMM and FCCM) and one or more components associated with thermal management system 300/400 and/or fuel cell system 310/410. For brevity, the discussion of method 600 focuses on thermal system components of thermal management system 300, however, it should be appreciated that the steps of method 600 may apply to any thermal management system, including thermal management systems 200 and 400 described previously. In general, method 600 may be configured to facilitate heat transfer from certain vehicle components/systems to the fuel cell stacks in order to thaw the fuel cell stacks and enable desired fuel cell system and vehicle operation.

Method 600 begins at block 602. At block 604, TMM enables a default thermal management operating mode. In the default thermal management operating mode, TMM commands both valve 370A and valve 370B to fully closed positions. In other words, TMM commands each of valve 370A and 370B to a 0% position. As a result, coolant flowing through first fuel cell coolant loop 302A and second fuel cell coolant loop 302B are recirculated throughout the respective fuel cell coolant loops and prevented from flowing through first coolant-coolant heat exchanger 366A and second coolant-coolant heat exchanger 366B, respectively.

At block 606, TMM receives a heat power request from first fuel cell stack 310A (i.e., FC1_{HTPR}). In various embodiments, FC1_{HTPR} may be communicated by FCCM to TMM and may indicate that power is being requested to heat first fuel cell stack 310A, for example, in response to vehicle 100 being turned on and/or preparing for operation. In certain embodiments, FC1_{HTPR} is communicated to TMM at regular intervals, for example, between every 50 milliseconds (ms) and 150 ms, between every 75 ms and 125 ms, or every 100 ms. In some embodiments, FC1_{HTPR} may be an indication that first fuel cell stack 310A is on but requires heating to operate at a desired power output. In some embodiments, FC1_{HTPR} may be compared to a threshold power (e.g., 0 kilowatts (kW)), and if FC1_{HTPR} is greater than the threshold power, method 600 proceeds to block 608.

At block 608, TMM receives a first temperature indicative of a thermal state of first fuel cell stack 310A (i.e., FC1_{TEMP}) and a second temperature indicative of a thermal state of second fuel cell stack 310B (i.e., FC2_{TEMP}). In various embodiments, TMM receives FC1_{TEMP} and FC2_{TEMP} from FCCM, however, TMM may also receive FC1_{TEMP} and FC2_{TEMP} directly from first fuel cell stack 310A and second fuel cell stack 310B, respectively. In certain embodiments, FC1_{TEMP} and FC2_{TEMP} are communicated to TMM at regular intervals, for example, between every 50 milliseconds (ms) and 150 ms, between every 75 ms and 125 ms, or every 100 ms. In various embodiments, FC1_{TEMP} and FC2_{TEMP} are measured coolant temperatures at the outlets of first fuel cell stack 310A and second fuel cell stack 310B, respectively, however, FCT_{TEMP} and FC2_{TEMP} may alternatively be coolant temperatures at the inlets of the stacks or internal/external temperatures associated with the stacks. At block 608, TMM further compares FC1_{TEMP} and FC2_{TEMP} to a first threshold temperature (e.g., 10° C.). In various embodiments, the first threshold temperature may correlate to a temperature under which the fuel cell stack is considered to be in a frozen state. In various embodiments, the first threshold temperature may be between 0° C. and 20° C., between 5° C. and 15° C., or approximately 10° C. Responsive to both FC1_{TEMP} and FC2_{TEMP} being below the first threshold temperature, which may be indicative that both first fuel cell stack 310A and second fuel cell stack 310B are in a frozen state, method 600 moves to block 610. Optionally, prior to, contemporaneous with, or after TMM receives FC1_{TEMP} and FC2_{TEMP}, TMM may receive a pump speed associated with fuel cell coolant loop pump 338A, which may be indicative of adequate coolant flow. In various embodiments, the pump speed may be compared with a threshold pump speed to determine whether adequate coolant flow can be achieved. In some embodiments, the threshold pump speed may be between 0 and 400 rotations per minute (RPM), between 100 RPM and 300 RPM, or approximately 200 RPM.

At block 610, TMM initiates stage one of a freeze-start thermal operating mode for first fuel cell stack 310A. In general, stage one of the freeze-start thermal operating mode may be initiated in response to a determination that both first fuel cell stack 310A and second fuel cell stack 310B are in a frozen state. At block 610, TMM commands valve 370A to a fully open position (i.e., 100% position) to enable coolant to flow through coolant-coolant heat exchanger 366A. At block 610, valve 370B remains in a fully closed position (i.e., 0% position), thereby preventing coolant from flowing through coolant-coolant heat exchanger 366B.

At block 610, TMM further commands a brake resistor power (i.e., a power of brake resistor 340A and/or 340B) to a maximum power. In some embodiments, such as embodiments where the thermal management system comprises a single brake resistor, commanding the brake resistor power to the maximum power may comprise commanding the brake resistor power to the maximum brake resistor operating power. In some embodiments, such as embodiments where the thermal management system comprises two or more brake resistors, commanding the brake resistor power to the maximum power may comprise commanding the brake resistor power for each brake resistor to the maximum operating power. In other embodiments, commanding the brake resistor power to the maximum power may comprise commanding the brake resistor power for each brake resistor to one half of its maximum operating power. In some embodiments, the maximum brake resistor operating power may be between 0 and 40 kW, between 10 and 30 kW, or approximately 20 kW. In other words, brake resistor 340A and/or 340B may be configured to receive ˜20 kW worth of power from the HV bus of vehicle 100 and convert that power to thermal energy.

At block 610, TMM further sets a coolant temperature setpoint (in other words, a temperature of the coolant traveling through brake resistor coolant loop 304) at an outlet of brake resistors 340A and/or 340B. In some embodiments, the coolant temperature setpoint may be an inlet coolant temperature setpoint. In some embodiments, the coolant temperature setpoint may be between 0° C. and 80° C., between 20° C. and 60° C., or approximately 40° C. In various embodiments, TMM controls the brake resistor power in a manner to achieve the coolant temperature setpoint over time. More specifically, as first fuel cell stack 310A becomes heated, the coolant in brake resistor coolant loop 304 may rise in temperature, and the brake resistor power may be adjusted downward to ensure the coolant temperature remains at or close to the temperature setpoint. In some embodiments, a PID controller, which may be included as part of or separate from the TMM, may be used to control the brake resistor power to achieve the coolant temperature setpoint. In some embodiments, TMM may utilize control logic and methods identical to or similar to those described in co-pending U.S. patent application Ser. No. 18/322,283, filed May 23, 2023, entitled “FUEL CELL THERMAL MANAGEMENT CONTROL SYSTEMS AND METHODS.”

At block 610, TMM further commands valve 344 to a fully open position (i.e., 100% position). In the fully open position, valve 344 diverts coolant flowing through brake resistor coolant loop 304A to cabin heater core 352 and bypasses brake resistor radiator 354. As a result, any heat from the coolant as it travels through brake resistor coolant loop 304 is lost to the vehicle cabin (which may require heating regardless due to the ambient temperature) rather than the ambient environment. In some embodiments, at block 610, TMM further commands fan 358 to a minimum speed (e.g., 0 RPM) given no cooling is desired.

At block 610, TMM further commands a pump speed (i.e., speed of pump 364A and/or 364B) to a maximum speed. In some embodiments, such as embodiments where the thermal management system comprises a single brake resistor coolant loop pump, commanding the pump speed to the maximum speed may comprise commanding the brake resistor pump to the maximum operating speed. In some embodiments, such as embodiments where the thermal management system comprises two or more brake resistor pumps, commanding the pump speed to the maximum speed may comprise commanding the speed for each pump to its maximum operating speed. In other embodiments, commanding the pump speed to the maximum speed may comprise commanding the pump speed for each pump to one half of its maximum operating speed.

As may be apparent from the commands of block 610 described above, the first stage of the freeze-start thermal operating mode for first fuel cell stack 310A is configured to utilize heat from brake resistor 340A and/or 340B to thaw first fuel cell stack 310A. More specifically, heat generated via resistive heating in brake resistor 340A and/or 340B may be transferred to the coolant in brake resistor coolant loop 304, and in turn, transferred to the coolant in first fuel cell coolant loop 302A via first coolant-coolant heat exchanger 366A. Upon reaching a threshold temperature, first fuel cell stack 310A becomes operable, and able to generate heat in the process, without the need for heat from brake resistor 340A and/or 340B.

At block 612, TMM receives power requests and temperatures indicative of a thermal state of first fuel cell stack 310A and second fuel cell stack 310B. As discussed above, TMM may receive FC1_{HTPR}, FC1_{TEMP}, and FC2_{TEMP} at regular intervals. In various embodiments, TMM also receives a power request from second fuel cell stack 310B (i.e., FC2_{HTPR}) at regular intervals. At block 612, TMM compares FC1_{HTPR} and FC2_{HTPR} to the threshold power (e.g., 0 kW) and compares FC1_{TEMP} and FC2_{TEMP} to a second threshold temperature (e.g., 28° C.) which may be indicative of a heated state of first fuel cell stack 310A and/or second fuel cell stack 310B. In various embodiments, the second threshold temperature correlates to a minimum operating temperature at which the fuel cell stack can operate in view of power output, efficiency, and/or durability requirements. In various embodiments, the second threshold temperature may be between 10° C. and 50° C., between 20° C. and 40° C., or approximately 28° C. In various embodiments, the second threshold temperature may be selected so as to avoid overheating of the relevant fuel cell stack, which could damage the stack. If at block 612 TMM determines that each of FC1_{HTPR} and FC2_{HTPR} are less than or equal to the threshold power (indicating first fuel cell stack 310A and second fuel cell stack 310B are not requesting heating), or FC1_{TEmP} or FC2_{TEMP} are greater than or equal to the second threshold temperature (indicating at least one of the fuel cell stacks has been sufficiently heated), method 600 moves to block 614 to terminate the first stage of the freeze-start thermal operating mode for first fuel cell stack 310A. Otherwise, method 600 returns to block 606. Optionally, at block 612, TMM may further receive a pump speed of pump 338A and 338B and compare the pump speeds with a threshold pump speed (e.g., 200 RPM). In the event the pump speed of pump 338A and 338B are both determined to be less than or equal to the threshold pump speed (indicating there is insufficient coolant flow to heat first fuel cell stack 310A and/or second fuel cell stack 310B), method 600 moves to block 614 to terminate the first stage of the freeze-start thermal operating mode for first fuel cell stack 310A.

At block 614, TMM commands both valve 370A and valve 370B to fully closed positions (i.e., 0% position), thereby preventing coolant from flowing through first coolant-coolant heat exchanger 366A and second coolant-coolant heat exchanger 366B. At block 614, TMM further commands the brake resistor (e.g., 340A and/or 340B) off (i.e., commands a brake resistor power to 0 kW), reduces the coolant temperature setpoint at the outlet of brake resistors 340A and 340B (i.e., reduces the coolant temperature setpoint in the first stage of the freeze-start thermal operating mode by an equal amount (e.g., reduces the coolant temperature setpoint by 40° C.)), commands valve 344 to a fully closed position (i.e., 0% position), commands the pump speed (e.g., speed of pump 364A and/or 364B) to half speed (i.e., 50% speed). In other words, at block 614, TMM commands brake resistors 340A and/or 340B to cease drawing power for the purpose of heating first fuel cell stack 310A, and instead allows first fuel cell stack 310A (now operating) to transfer heat to/receive heat from the coolant in fuel cell coolant loop 302A to maintain the temperature and/or further heat first fuel cell stack 310A. In various embodiments, TMM commands the pump speed (e.g., speed of pump 364A and/or 364B) to half speed to avoid any delays in providing heat to/removing heat from the brake resistor (e.g., 340A and/or 340B) during times in which the brake resistor is operational.

Returning momentarily to block 606, in the event TMM determines that FC1_{HTPR} is not greater than the threshold power (i.e., 0 kW), method 600 moves to block 616 and compares FC2_{HTPR} to the threshold power. If FC2_{HTPR} is not greater than the threshold power, method 600 returns to block 602. If FC2_{HTPR} is greater than the threshold power, method moves to block 618, which may be identical or substantially identical to block 608 described previously. More specifically, at block 618, TMM compares FC1_{TEMP} and FC2_{TEMP} to the first threshold temperature (e.g., 10° C.) to determine if both first fuel cell stack 310A and second fuel cell stack 310B are in a frozen state. If so, method 600 proceed to blocks 620, 622, and 624 and initiates, monitors, and terminates a first stage of a freeze-start thermal operating mode for second fuel cell stack 310B. The first stage of the freeze-start thermal operating mode for second fuel cell stack 310B may be similar to the first stage of the freeze-start thermal operating mode for first fuel cell stack 310A, with the exception that valve 370B is commanded by the TMM to a fully open position, while valve 370A remains closed. As such, in the first stage of the freeze-start thermal operating mode for second fuel cell stack 310B, heat generated by brake resistors 340A and/or 340B is transferred to second fuel cell stack 310B rather than first fuel cell stack 310A.

Returning to block 608, in the event TMM determines that at least one of FC1_{TEMP} or FC2_{TEMP} are not less than the first threshold temperature (e.g., 10° C.), method 600 moves to block 626. At block 626, TMM compares FC1_{TEMP} to a third threshold temperature (e.g., 25° C.). In some embodiments, the second threshold temperature (e.g., 28° C.) forms an upper limit of a hysteresis band and the third threshold temperature (e.g., 25° C.) forms a lower limit of the hysteresis band. This hysteresis band may be useful in situations where the coolant temperature fluctuates around the third threshold temperature (e.g., 25° C.). In some embodiments, the third threshold temperature may be between 5° C. and 45° C., between 15° C. and 35° C., or approximately 25° C. If FC1_{TEMP} is determined to be less than the third threshold temperature, method 600 continues to block 628, otherwise, method 600 returns to block 602.

At block 628, TMM compares FC2_{TEMP} to the first threshold temperature (e.g., 10° C.) and determines whether FC2_{TEMP} is greater than or equal to the first threshold temperature. In the event TMM determines FC2_{TEMP} is greater than or equal to the first threshold temperature, method 600 continues to block 630 and initiates stage two of the freeze-start thermal operating mode for first fuel cell stack 310A; otherwise, method 600 returns to block 606. Optionally, prior to, contemporaneous with, or after TMM receives FC1_{TEMP} and FC2_{TEMP}, TMM may receive a pump speed associated with fuel cell coolant loop pump 338B, which may be indicative of thermal management system 300's ability to transfer heat from second fuel cell stack 310B to first fuel cell stack 310A via coolant-coolant heat exchanger 366B.

Pausing momentarily, blocks 606, 608, 626, and 628 collectively seek to determine if first fuel cell stack 310A is sufficiently cold/in need of an external heat source and second fuel cell stack 310B is sufficiently warm/able to act as an external heat source to enable heat transfer from second fuel cell stack 310B to first fuel cell stack 310A. More specifically, at block 606, TMM determines that first fuel cell stack 310A is requesting heating and at block 608, TMM determines that at least one of first fuel cell stack 310A or second fuel cell stack 310B are in a nonfrozen (operable) state. At block 628, TMM determines that first fuel cell stack 310A is sufficiently cool (i.e., less than the third threshold temperature which is indicative of a heated state) such that additional heating is desired and/or possible without overheating and/or damaging first fuel cell stack 310A. At block 630, TMM determines that second fuel cell stack 310B is in a nonfrozen (operable) state, and therefore it is assumed that second fuel cell stack 310B is sufficiently heated/operational such that second fuel cell stack 310B is able to assist in heating first fuel cell stack 310A.

Returning to block 630, TMM initiates stage two of the freeze-start thermal operating mode for first fuel cell stack 310A. Stage two of the freeze-start thermal operating mode utilizes heat from brake resistors 340A and/or 340B, in addition to heat from second fuel cell stack 310B, to heat first fuel cell stack 310A. At block 630, TMM commands valves 370A and 370B to fully open positions (i.e., 100% position). As a result, coolant flowing through first fuel cell coolant loop 302A and second fuel cell coolant loop 302B are permitted to flow through coolant-coolant heat exchanger 366A and coolant-coolant heat exchanger 366B, respectively, to permit heat transfer with the coolant in brake resistor coolant loop 304. Furthermore, by opening valve 370B in stage two, heat from second fuel cell stack 310B, which is now sufficiently heated/operational to permit heat transfer to first fuel cell stack 310A, is able to be transferred to the coolant in brake resistor coolant loop 304 via coolant-coolant heat exchanger 366B, and in turn, able to be transferred to the coolant in first fuel cell coolant loop 302A via coolant-coolant heat exchanger 366A to heat first fuel cell stack 310A.

At block 630, TMM further commands a brake resistor power (i.e., power of brake resistors 340A and/or 340B), sets a coolant temperature setpoint at an outlet of brake resistors 340A and/or 340B, commands a position of valve 344, commands a pump speed (i.e., speed of pumps 364A and/or 364B), and commands a brake resistor radiator fan speed (i.e., speed of fan 358). In various embodiments, with the exception of the position of valve 370B, the commands and setpoints communicated by TMM in block 630 may be identical to the commands and setpoints communicated by TMM in block 610 discussed above. As a result, in stage two of the freeze-start thermal operating mode for first fuel cell stack 310A, collective heat from brake resistors 340A, 340B, and second fuel cell stack 310B is used to heat first fuel cell stack 310A.

At block 632, TMM receives power requests and temperatures indicative of a thermal state of first fuel cell stack 310A and second fuel cell stack 310B. As discussed above, TMM may receive FC1_{HTPR}, FC2_{HTPR}, FC1_{TEMP}, and FC2_{TEMP} at regular intervals. At block 632, similar to block 612, TMM compares FC1_{HTPR} and FC2_{HTPR} to the threshold power (e.g., 0 kW) and compares FC1_{TEMP} and FC2_{TEMP} to a second threshold temperature (e.g., 28° C.) which may be indicative of a heated state of first fuel cell stack 310A and/or second fuel cell stack 310B. If at block 632 TMM determines that each of FC1_{HTPR} and FC2_{HTPR} are less than or equal to the threshold power, or FC1_{TEMP} and FC2_{TEMP} are greater than or equal to the second threshold temperature (indicating that both first fuel cell stack 310A and second fuel cell stack 310B have been sufficiently heated and/or are operational), method 600 moves to block 634 to terminate stage two of the freeze-start thermal operating mode for first fuel cell stack 310A. Otherwise, method 600 returns to block 606. In various embodiments, the actions taken at block 634 are identical or substantially identical to the actions taken at block 614. Optionally, prior to, contemporaneous with, or after TMM receives FC1_{HTPR}, FC2_{HTPR}, FC1_{TEMP}, and FC2_{TEMP}, TMM may receive a pump speed of pumps 338A and 338B, and in the event at least one pump speed is below a threshold pump speed (e.g., 200 RPM), method 600 moves to block 634 to terminate stage two of the freeze-start thermal operating mode for first fuel cell stack 310A.

Returning to block 618, in the event TMM determines that at least one of FC1_{TEMP} or FC2_{TEMP} are not less than the first threshold temperature (e.g., 10° C.) (and therefore at least one of first fuel cell stack 310A or second fuel cell stack 310B is in an operable state), method 600 moves to block 636. In general, blocks 636 through 644 are substantially similar to blocks 626 through 634, with the exception that blocks 636 through 644 are intended to identify and initiate stage two of the freeze-start thermal operating mode for second fuel cell stack 310B rather than first fuel cell stack 310A. Therefore, rather than using heat from brake resistors 340A and/or 340B and second fuel cell stack 310B to heat first fuel cell stack 310A, block 640 uses heat from brake resistors 340A and/or 340B and first fuel cell stack 310A to heat second fuel cell stack 310B.

The systems and methods described herein enable existing vehicle architecture and/or components (i.e., brake resistors) to be used to heat a fuel cell system in freeze-start scenarios, thereby eliminating the need for designated components such as electric heaters. As a result, vehicle weight, cost, complexity, and bill of materials can be reduced. Additionally, by using heat generated by one fuel cell stack to heat another fuel cell stack, thermal efficiency of the thermal management system can be improved which, in turn, results in more efficient vehicle operation and extended vehicle range.

Computer programs (also referred to as computer control logic) are stored in main memory and/or secondary memory. Computer programs may also be received via communications interface. These computer program instructions may be loaded onto a general-purpose computer, special purpose computer, controller, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer, controller, or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

In various embodiments, software may be stored in a computer program product and loaded into a computer system using a removable storage drive, hard disk drive, or communications interface. The control logic (software), when executed by the processor or controller, causes the processor or controller to perform the functions of various embodiments as described herein. In various embodiments, hardware components may take the form of application specific integrated circuits (ASICs). Implementation of the hardware so as to perform the functions described herein will be apparent to persons skilled in the relevant art(s).

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet-based embodiment (e.g., an internet-based driving command system), an entirely hardware embodiment, or an embodiment combining aspects of the internet, software, and hardware. Furthermore, the system may take the form of a computer program product on a computer-readable storage medium having computer-readable program code means embodied in the storage medium. Any suitable computer-readable storage medium may be utilized, including hard disks, solid state storage media, CD-ROM, BLU-RAY DISC®, optical storage devices, magnetic storage devices, and/or the like.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like. Still further, the system could be used to detect or prevent security issues with a client-side scripting language, such as JAVASCRIPT®, VBScript, or the like.

The system and method are described herein with reference to screen shots, block diagrams and flowchart illustrations of methods, apparatus, and computer program products according to various embodiments. It will be understood that each functional block of the block diagrams and the flowchart illustrations, and combinations of functional blocks in the block diagrams and flowchart illustrations, respectively, can be implemented by computer program instructions.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

System program instructions and/or controller instructions may be loaded onto a non-transitory, tangible computer-readable medium having instructions stored thereon that, in response to execution by a controller, cause the controller to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” or “at least one of A, B, and C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Methods, systems, and articles are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for heating a dual stack fuel cell system of a vehicle, the method comprising:
receiving a heat power request from a first fuel cell stack;
receiving a first temperature of the first fuel cell stack and a second temperature of a second fuel cell stack;
initiating, responsive to the first temperature and the second temperature indicating that the first fuel cell stack and the second fuel cell stack are frozen, a freeze-start thermal operating mode for the first fuel cell stack; and
transferring, during the freeze-start thermal operating mode for the first fuel cell stack, heat from a brake resistor to the first fuel cell stack.

2. The method of claim 1, wherein the first temperature is a measured coolant temperature at an outlet of the first fuel cell stack and the second temperature is a measured coolant temperature at an outlet of the second fuel cell stack.

3. The method of claim 1, further comprising comparing the heat power request to a threshold power value.

4. The method of claim 1, further comprising commanding, during the freeze-start thermal operating mode for the first fuel cell stack, a brake resistor power to a maximum operating power.

5. The method of claim 1, further comprising comparing the first temperature and the second temperature to a first threshold temperature to determine if the first fuel cell stack and the second fuel cell stack are frozen.

6. The method of claim 4, further comprising setting, during the freeze-start thermal operating mode for the first fuel cell stack, a coolant temperature setpoint at an outlet of the brake resistor.

7. The method of claim 6, further comprising controlling, during the freeze-start thermal operating mode for the first fuel cell stack, the brake resistor power based on the coolant temperature setpoint at the outlet of the brake resistor.

8. The method of claim 1, further comprising receiving a third temperature of the first fuel cell stack and a fourth temperature of the second fuel cell stack.

9. The method of claim 8, further comprising terminating, responsive to the third temperature or the fourth temperature being greater than or equal to a second threshold temperature, the freeze-start thermal operating mode for the first fuel cell stack.

10. A method for heating a dual stack fuel cell system of a vehicle, the method comprising:
receiving a heat power request from a first fuel cell stack;
receiving a first temperature of the first fuel cell stack and a second temperature of a second fuel cell stack;
determining a first thermal state of the first fuel cell stack using the first temperature and a second thermal state of the second fuel cell stack using the second temperature;
initiating, responsive to the first thermal state being a frozen thermal state and the second thermal state being an operable thermal state, a freeze-start thermal operating mode for the first fuel cell stack; and
transferring, during the freeze-start thermal operating mode for the first fuel cell stack, heat from the second fuel cell stack to the first fuel cell stack.

11. The method of claim 10, further comprising transferring, during the freeze-start thermal operating mode for the first fuel cell stack, heat from a brake resistor to the first fuel cell stack.

12. The method of claim 10, further comprising commanding, during the freeze-start thermal operating mode for the first fuel cell stack, a first valve to a fully open position and a second valve to a fully open position.

13. The method of claim 12, wherein the first valve is positioned between the first fuel cell stack and a first coolant-coolant heat exchanger, and the second valve is positioned between the second fuel cell stack and a second coolant-coolant heat exchanger.

14. The method of claim 13, wherein the first valve permits a first coolant to pass through the first coolant-coolant heat exchanger when in the fully open position, and wherein the second valve permits a second coolant to pass through the second coolant-coolant heat exchanger when in the fully open position.

15. The method of claim 11, further comprising commanding a brake resistor power to a maximum operating power.

16. The method of claim 11, further comprising commanding a pump speed of a pump in a brake resistor coolant loop to a maximum speed.

17. The method of claim 11, further comprising setting a coolant temperature at an outlet of the brake resistor.

18. A method of heating a dual stack fuel cell system of a vehicle, the method comprising:
receiving a first temperature of a first fuel cell stack and a second temperature of a second fuel cell stack;
determining a first thermal state of the first fuel cell stack using the first temperature and a second thermal state of the second fuel cell stack using the second temperature; and
commanding, responsive to a determination that the first thermal state is a frozen state and the second thermal state is a frozen state, a first valve to an open position to enable heat transfer from a brake resistor to the first fuel cell stack.

19. The method of claim 18, further comprising comparing the first temperature and the second temperature to a threshold temperature to determine the first thermal state and the second thermal state.

20. The method of claim 18, wherein the first valve is positioned between the first fuel cell stack and a coolant-coolant heat exchanger thermally coupled to the brake resistor.
